(19) United States
(12) Patent Application Publication
(10) Pub. No.: US 2024/0331213 A1
(43) Pub. Date: Oct. 3, 2024

(54) METHOD FOR ASCERTAINING A DESCRIPTOR IMAGE FOR AN IMAGE OF AN OBJECT

(71) Applicant: Robert Bosch GmbH, Stuttgart (DE)

(72) Inventors: Andras Gabor Kupcsik, Herrenberg (DE); Christian Graf, Muenchen (DE); David Adrian, Stuttgart (DE); Joshua Weil, Stuttgart (DE)

(21) Appl. No.: 18/602,504

(22) Filed: Mar. 12, 2024

(30) Foreign Application Priority Data
Mar. 31, 2023 (DE) 10 2023 203 021.7

(51) Int. Cl. G06T 11/00; G06T 7/70; G06V 10/764

(52) U.S. Cl. CPC G06T 11/00; G06T 7/70; G06V 10/764; G06T 2207/20084

(57) ABSTRACT

A method for ascertaining a descriptor image for an image of an object. The method includes training, for each of a plurality of object classes, a respective machine learning model to map images of objects of the object class to descriptor images and storing reference descriptors output by the machine learning model for one or more objects of the object class; receiving an image of an object; generating, for each object class, a respective descriptor image for the object by mapping the received image to a descriptor image using the machine learning model trained for the object class; evaluating, for each object class, the distance between the reference descriptors stored for the object class and the descriptors of the descriptor image generated for the object class; and assigning the descriptor image to the object as the descriptor image of the object generated for an object class based on the distance.

### CROSS REFERENCE

The present application claims the benefit under 35 U.S.C. § 119 of German Patent Application No. DE 10 2023 203 021.7 filed on Mar. 31, 2023, which is expressly incorporated herein by reference in its entirety.

### FIELD

The present invention relates to methods for ascertaining a descriptor image for an image of an object, in particular for controlling a robot device.

### BACKGROUND INFORMATION

In order to enable flexible production or processing of the objects by a robot, it is desirable for the robot to be able to handle an object regardless of the position in which the object is placed in the workspace of the robot. The robot should therefore be able to recognize which parts of the object are in which positions, so that it can, for instance, grab the object at the correct location, for example to fasten it to another object or weld the object at the current location. This means that the robot should be able to recognize the pose (position and orientation) of the object, for example from one or more images taken by a camera attached to the robot, or ascertain the position of locations for picking up or processing. One approach to achieving this is determining descriptors, i.e., points (vectors) in a predefined descriptor space, for parts of the object (i.e. pixels of the object represented in an image plane), wherein the robot is trained to assign the same descriptors to the same parts of an object regardless of a current pose of the object and thus recognize the topology of the object in the image, so that it is then known, for example, where which corner of the object is located in the image. Knowing the pose of the camera then makes it possible to infer the pose of the object. The recognition of the topology can be realized with a machine learning model (ML model) that is trained accordingly.

If a machine learning model is appropriately trained for a particular (first) class of objects, the machine learning model provides consistent descriptors for that class of objects. If descriptors are later also needed for objects that are not in this class, e.g., because a new model is to be processed by a robot, the machine learning model has to be trained for this other (second) class, or even trained for both classes of objects together, so that it can then provide descriptors for both classes of objects. The original training for the first class of objects is then lost, however, which makes this manner of expanding the class of objects for which descriptor images can be generated inefficient and can also lead to inconsistencies in the descriptor ascertainment. Therefore approaches that permit more efficient and consistent generation of descriptor images for images of objects are desired, in particular when the class of objects for which descriptor images can be generated is to be expanded.

### SUMMARY

A method for ascertaining a descriptor image for an image of an object is provided according to various embodiments of the present invention, which comprises training, for each of a plurality of object classes, of a respective machine learning model to map images of objects of the object class to descriptor images (e.g. in each case as a function of the pixel values of the respective image of the respective object) and storing reference descriptors output by the machine learning model for one or more objects of the object class, receiving an image of an object, generating, for each object class, a respective descriptor image for the object by mapping the received image to a descriptor image using the machine learning model trained for the object class, evaluating, for each object class, the distance between the reference descriptors stored for the object class and the descriptors of the descriptor image generated for the object class and assigning the descriptor image to the object as the descriptor image of the object generated for that object class, for which the distance between the reference descriptors stored for the object class and the descriptors of the descriptor image generated for the object class was rated to be the smallest.

The above-described method of the present invention makes it possible to sequentially train a machine learning model (i.e., multiple respective instances thereof), e.g., a dense visual descriptor network, on different object sets (i.e., object classes). This enables an expansion of the manageable objects to include additional object classes without having to completely retrain (for all object classes), i.e., without losing the result of the training for one or more previous object classes. This reduces training effort and avoids inconsistency in descriptor ascertainment.

Various embodiment examples of the present invention are provided in the following.
Embodiment example 1 is a method for controlling a robot as described above.
Embodiment example 2 is a method according to embodiment example 1, wherein the distance between the reference descriptors and the descriptor image is evaluated by assigning each of the reference descriptors to a descriptor of the descriptor image and averaging (i.e. calculating a (possibly weighted) mean) of the distances between the reference descriptors and their assigned descriptors.

A reference descriptor is assigned to its closest descriptor (in the descriptor space), for example, but additional information, such as the position of reference (key) points (i.e. points that are mapped to the reference descriptors) relative to one another can be taken into account in the assignment as well. This enables robust assignment of objects to object classes.
Embodiment example 3 is a method according to embodiment example 1 or 2, wherein at least some of the machine learning models in a sub-model match.

The machine learning models can use the same backbone network, for instance. This reduces the training effort of one of the machine learning models for a newly added object class.
Embodiment example 4 is a method according to embodiment example 3, comprising training the sub-model using training data containing objects from all object classes.

This ensures that, for each object class for which a machine learning model that uses the sub-model is being trained, the machine learning model can be trained to perform well for the respective object class.
Embodiment example 5 is a method according to one of embodiment examples 1 to 4, wherein, for each object class, the respective machine learning model is trained using a training data set that contains images of objects of the object class, wherein the objects of the object class are overrepresented in the training data set.

Thus, each machine learning model is specialized to its object class, so that it ascertains descriptors for objects of its object class precisely and consistently.
Embodiment example 6 is the method according to one of embodiment examples 1 to 5, wherein at least some the machine learning model are neural networks.

In other words, a dense object net is trained for at least some of the object classes. These can be used to achieve good results for generating descriptor images.
Embodiment example 7 is a method for controlling a robot to pick up or process an object, comprising ascertaining a descriptor image of the object according to a method according to one of embodiment examples 1 to 6, ascertaining the position of a location or a pose for picking up or processing the object in the current control scenario from the ascertained descriptor image and controlling the robot to pick up or process the object according to the ascertained position, location or according to the ascertained pose.
Embodiment example 8 is a control unit configured to carry out a method according to one of embodiment examples 1 to 7.
Embodiment example 9 is a computer program comprising instructions that, when executed by a processor, cause said processor to carry out a method according to one of embodiment examples 1 to 7.
Embodiment example 10 is a computer-readable medium which stores instructions that, when executed by a processor, cause said processor to carry out a method according to one of embodiment examples 1 to 7.

### BRIEF DESCRIPTION OF THE DRAWINGS

In the figures, like reference signs generally refer to the same parts throughout the different views. The figures are not necessarily to scale, wherein emphasis is instead generally placed on representing the principles of the present invention. In the following description, various aspects are described with reference to the figures.

FIG. 1 shows a robot according to an example embodiment of the present invention.

FIG. 2 illustrates ascertaining a descriptor image for an image of an object, according to one example embodiment of the present invention.

FIG. 3 shows a flowchart depicting a method for ascertaining a descriptor image for an image of an object according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure to form new aspects.

Different examples will be described in more detail in the following.

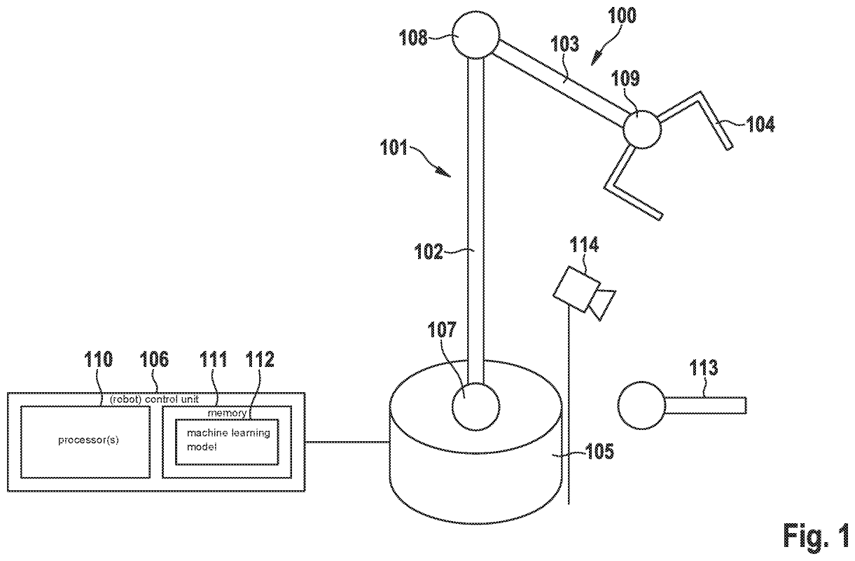

FIG. 1 shows a robot 100.

The robot 100 includes a robot arm 101, for example an industrial robot arm for handling or assembling a workpiece (or one or more other objects). The robot arm 101 includes manipulators 102, 103, 104 and a base (or support) 105 by means of which the manipulators 102, 103, 104 are supported. The term “manipulator” refers to the movable components of the robot arm 101, the actuation of which enables physical interaction with the surroundings, e.g. in order to carry out a task. For control, the robot 100 includes a (robot) control unit 106 designed to implement the interaction with the surroundings according to a control program. The last component 104 (which is furthest from the support 105) of the manipulators 102, 103, 104 is also referred to as the end effector 104 and can include one or more tools, such as a welding torch, gripping tool, painting device, or the like.

The other manipulators 102, 103 (which are closer to the support 105) can form a positioning device so that, together with the end effector 104, the robot arm 101 is provided with the end effector 104 at its end. The robot arm 101 is a mechanical arm that can provide functions similar to those of a human arm (possibly with a tool at its end).

The robot arm 101 can include articulation elements 107, 108, 109 which connect the manipulators 102, 103, 104 to one another and to the support 105. An articulation element 107, 108, 109 can comprise one or more articulation joints that can each provide a rotary movement (i.e. rotational movement) and/or translational movement (i.e. displacement) for associated manipulators relative to one another. The movement of the manipulators 102, 103, 104 can be initiated by means of actuators controlled by the control unit 106.

The term “actuator” can be understood to mean a component that is configured to effect a mechanism or process in reaction to being driven. The actuator can implement instructions (the so-called activation) created by the control unit 106 into mechanical movements. The actuator, e.g. an electromechanical converter, can be designed to convert electrical energy into mechanical energy in reaction to being driven.

The term “control unit” can be understood to mean any type of logic-implementing entity that can, for example, include a circuit and/or a processor capable of executing software, firmware, or a combination thereof stored in a storage medium, and can issue instructions, e.g. in the present example to an actuator. The control unit can, for example, be configured using program code (e.g. software) to control the operation of a system; in the present example a robot.

In the present example, the control unit 106 includes one or more processors 110 and a memory 111 that stores code and data on the basis of which the processor 110 controls the robot arm 101. According to various embodiments, the control unit 106 controls the robot arm 101 on the basis of a machine learning model 112 stored in the memory 111.

The control unit 106 uses the machine learning model 112 to ascertain the pose of an object 113 positioned in a workspace of the robot arm 101, for example. Depending on the ascertained pose, the control unit 106 can, for example, decide which location of the object 113 the end effector 109 should grab (or process in some other way).

The control unit 106 ascertains the pose using the machine learning model 112 using one or more camera images of the object 113. The robot 100 can be equipped with one or more cameras 114, for example, that allow it to take images of its workspace. The camera 114 is attached to the robot arm 101, for example, so that the robot can take images of the object 113 from different perspectives by moving the robot arm 101 around. It is, however, also possible to provide one or more fixed cameras.

According to various embodiments, the machine learning model 112 is a (deep) neural network (NN) that generates a feature map for a camera image, e.g. in the form of an image in a feature space, that makes it possible to assign points in the (2D) camera image to points of the (3D) object.

The machine learning model 112 can, for example, be trained to assign a specific corner (or generally a key point) of the object a specific (unique) feature value (also referred to as a descriptor value or descriptor vector) in the feature space. If a camera image is then fed to the machine learning model 112 and the machine learning model 112 assigns this feature value to a point in the camera image, it can be inferred that the corner is situated at this location (i.e. at a location in the space, the projection of which onto the plane of the camera corresponds to the point in the camera image). Knowing the position of multiple points of the object in the camera image makes it possible to ascertain the pose of the object in the space. Thus, localizing (or tracking across multiple images) key points defined on the basis of the descriptor image (such as corners) makes it possible to ascertain the pose of an object in the workspace of the robot arm 101 for example. Applications such as identifying no grip regions or identifying grip preferences for robot manipulations, for instance, can be based on recognizing such defined key points.

The machine learning model 112 has to be appropriately trained for this task.

One example of a machine learning model 112 for object detection is a machine learning model that maps, an image of an object to a descriptor image; i.e. densely maps said image to visual descriptors.

Such a machine learning model (such as a dense object net (DON)) seeks to learn a dense (pixel-by-pixel) descriptor representation of an object, i.e. a dense visual representation of the object, for visual understanding (e.g. of a scene) and manipulation of the object. One example of this is a deep neural network that is trained in a self-supervised manner to convert an RGB input image into a descriptor image comprising a descriptor vector for each input pixel (i.e. ascertain a vector for each pixel of the input image). The result is a consistent object representation that can be used for visual understanding and manipulation. This allows images of known objects (or also unknown objects) to be mapped to descriptor images containing descriptors that identify locations on the objects independent of the perspective of the image. This provides a consistent representation of objects that can be used as the basis for control, e.g. for manipulating objects.

A method for training the machine learning model 112 to generate descriptor images for images of one or more objects (e.g. a DON) can be used, for instance, in which a static (i.e. stationary, e.g. permanently mounted) camera 114 can be used to take the images, i.e. training images are taken that show a respective training scene from only one perspective. Training data for the machine learning model are generated by augmenting captured training images of the training scene. This is done in two (or multiple) ways, so that, for each captured training image, the training data includes multiple augmented versions of the captured training image. Information about the used augmentations can then be used to ascertain which pixels correspond to one another (and should therefore be mapped to the same descriptor value by the machine learning model 112), thus enabling self-supervised training. Examples of augmentations (which make this possible and can therefore be used according to various embodiments) are random rotations, perspective and affine transformations.

When a machine learning model (e.g. a neural network such as a DON) is trained in this manner for a given set (or class) of objects A (i.e. the training data contain images of objects from that class), it is able to provide consistent dense visual descriptors for this class of objects. If dense visual descriptors are then needed for a different class of objects B, however, the machine learning model would have to be trained from scratch based on the training data of objects B. To achieve good performance for class A and B objects, a machine learning model can also be trained on a combined training data set with images of objects from both classes A and B. However, this means that the machine learning model has to be trained (again) from scratch and the previously learned ability to generate dense descriptor images for the class A objects is lost (in the sense that it is relearned and therefore the descriptors of the newly trained machine learning model for object class A are not consistent with the descriptors provided by the originally trained machine learning model), i.e.:
i) the training data for class A have to be retained for subsequent expansion to class B
ii) the representations learned for set A change when the neural network is retrained and are therefore not stable, which can lead to differences in the localization of key points for objects in class A, for example, and thus to inconsistent behavior (e.g. of a robot).
iii) it is computationally inefficient to retrain the entire machine learning model with all of the previous training data (for class A) whenever to-date unknown objects (class B) have to be handled.

The problem of learning different tasks (e.g. different object classes in the present case) one after the other without having to retrain a machine learning model (e.g. a neural network) from scratch is referred to as continuous or lifelong learning. If a machine learning model is trained for a “task 1” (e.g. creating descriptor images for object class A) and then for another “task 2” (e.g. creating descriptor images for object class B) the performance of the machine learning model for task 1 typically drops significantly. This phenomenon is referred to as “catastrophic forgetting”. Many different directions are being explored in the field of continuous learning. One class of methods-sometimes referred to as “architecture-based methods”—is showing promising results for classification tasks by mitigating catastrophic forgetting by separating different parts of the machine learning model for different tasks. However, the drawback of these methods is that the machine learning model usually needs to know which task it is supposed to perform. This means that, along with the input data (in the present case the image of an object), it is necessary to specify whether the machine learning model should solve task 1 or task 2 (or even another task N), so that it is known which part of the machine learning model should be used for inference.

The following describes an approach for generating descriptor images that eliminates the aforementioned shortcomings (i, ii and iii above or the necessary knowledge of the task to be performed, e.g. the object class from which an object originates). This is achieved, because the approach described in the following does not require training to be repeated for an object class that has already been trained for (as in the aforementioned example for object class A when object class B is added). As a result, in particular the descriptors generated for objects of the object class A remain stable.

For this example of an object class A and a later added object class B, according to various embodiments, an instance of a machine learning model (e.g. the machine learning model 112), for example a neural network (e.g. a DON), is first trained to generate descriptors for objects of object class A (i.e. map images of objects of object class A consistently to descriptor images, as described above).

If object class B is now added, a second instance of the machine learning model is trained to generate descriptors (only) for objects of object class B (i.e. the second instance of the machine learning model is trained for images of objects of object class B, not for images of objects of object class A).

The first instance of the machine learning model is retained, i.e. the resulting overall model, i.e. “system” of (instances of) machine learning models, is therefore still able to provide descriptors for object class A as before the addition of object class B (without the inconsistency resulting from the addition of object class B).

The result of the two training steps is thus an overall model that can generate dense visual descriptors for objects from both from both classes A and B (whereby those for class A are consistent with those that were generated before the addition of class B).

The set of objects that can be handled by the (overall) model can be successively expanded by training a respective model instance (e.g. a respective DON) for each object class that is added. The training of each instance can be carried out in different ways, e.g. using augmentations of images of objects of the respective object class, or also camera images of objects of the respective object class taken from different perspectives, or using different views of the objects generated by means of 3D models of objects of the respective object class.

If an overall model (e.g. with a first ML model instance trained for the A object class and a second ML model instance trained for the B object class) has now been generated and an image is now taken of an object for which a descriptor image is to be generated, but for which it is not clear whether it belongs to object class A or object class (for example) and it is therefore not clear which model instance is to be used, the procedure is as follows according to various embodiments.

One or more images (e.g. from the training data set for object class A) of objects of object class A are selected (in advance) as (first) reference images (and possibly stored) and a (first) set of descriptor values of points on objects shown in these reference images, i.e. (first) reference key points, are stored as (first) reference descriptors provided by the mapping of these (first) reference key points by the first ML model instance. Each object of object class A can have one or more reference key points.

Similarly, one or more images (e.g. from the training data set for object class B) of objects of object class B are selected as (second) reference images (and possibly stored) and a (second) set of descriptor values of (second) reference key points of the objects shown in these reference images are stored as (second) reference descriptors provided by the mapping of these (second) reference key points by the second ML model instance. Each object of object class B can have one or more reference key points.

The image of the object, the class affiliation of which is unknown, is now fed to both ML model instances and thus mapped to a first or a second descriptor image. It is now ascertained whether the first reference descriptors are closer to the descriptors of the first descriptor image or the second reference descriptors are closer to the descriptors of the second descriptor image, i.e. whether the distance between the first reference descriptors and the descriptors of the first descriptor image is less than the distance between the second reference descriptors and the descriptors of the second descriptor image or not.

“Closer” here is, for instance, an average minimum distance: The distance between the first reference descriptors and the descriptors of the first descriptor image is ascertained by calculating, for each first reference descriptor, the distance (distance between the two vectors in the descriptor space, e.g. corresponding to the Euclidean distance) to its closest descriptor of the first descriptor image (i.e. the minimum distance for the reference descriptor) and averaging over the (minimum) distances thus ascertained for the first reference descriptors (this averaging provides an evaluation of the distance between the first reference descriptors and the first descriptor image). The distance between the second reference descriptors and the descriptors of the second descriptor image is ascertained in the same way.

If the first reference descriptors are closer to the descriptors of the first descriptor image than the second reference descriptors are to the descriptors of the second descriptor image, it is assumed that the object belongs to object class A and the descriptor image provided by the first ML model instance is taken as the descriptor image of the object (e.g. for a pose detection of the object by means of the control unit 106). Conversely, if the second reference descriptors are closer to the descriptors of the second descriptor image than the first reference descriptors are to the descriptors of the first descriptor image, it is assumed that the object belongs to object class B and the descriptor image provided by the second ML model instance is taken as the descriptor image of the object. These assumptions are valid, because a machine learning model that is trained for one object class typically outputs “meaningless” descriptor values for objects of other object classes (i.e. descriptor values far outside a value range that the machine learning model selects during training as the descriptor range for the objects for which it is trained).

In order to train the mapping to descriptor images for object classes (each comprising one or more objects) one after the other, a separate model instance is provided for each object class and the following steps are carried out, for example:
1) When a new class of objects is added (e.g. presented as possible objects), a new model instance is trained from scratch for that class of objects (with appropriate training data) while retaining the previously trained model instances (e.g. NN weights). The model instances can also share a fixed backbone model, and only a part (“head”) is trained for each model instance (i.e. only the head is trained from scratch, for example, while the backbone is trained in advance over a broad set of objects, ideally from all object classes that can occur).
2) One or more reference images and descriptors of reference key points (reference descriptors) are stored for each object class. The information relating to which model instance was trained for which object class is stored as well. Additional information (distance or orientation between the reference key points on the object) can also be stored to contribute to the robustness of the identification of the correct object class.
3) For the inference (e.g. for a key point localization for an object in a camera image), the class affiliation of the object presented (in the camera image) is ascertained using the reference descriptors together with the respective model instance: If specific reference key points of an object class can be found on the presented object (or at least points comprising descriptors that are very close to the reference descriptors) it can be assumed that the object belongs to this object class and it is therefore known which model instance should be used in the inference for the object. For this purpose, the distance to the nearest descriptor of the descriptor image that the model instance trained for the object class provides for the camera image is ascertained for each reference descriptor for each object class. The sum of these distances is the (spacing or distance) score for the object class for the object. The object class the distance rating of which is the lowest is selected (i.e. identified as the object class to which the object belongs). The (optional) additional information (distance or orientation between the reference key points on the object) can be taken into account, for example by checking for reference descriptors for which closest descriptor values are found in a descriptor image, to see whether the points to which the found descriptor values belong (i.e. which have been mapped to them) have the correct distance or orientation to one another. Otherwise, a different assignment of reference descriptors and descriptor values, for example, is selected to determine the distances and thus for the calculation of the evaluation, or the evaluation is degraded by one penalty term).
4) The descriptor image provided by the model instance trained for the selected object class is used as the descriptor image of the camera image, e.g. for downstream tasks such as localizing key points of the object in the space.
5) If new objects (for which no model instance has yet been trained) are presented (which can be recognized by the fact that the distance ratings for these objects are above a threshold value for all previous object classes, for instance), a new model instance can be trained (in which case the previous model instances remain unchanged).

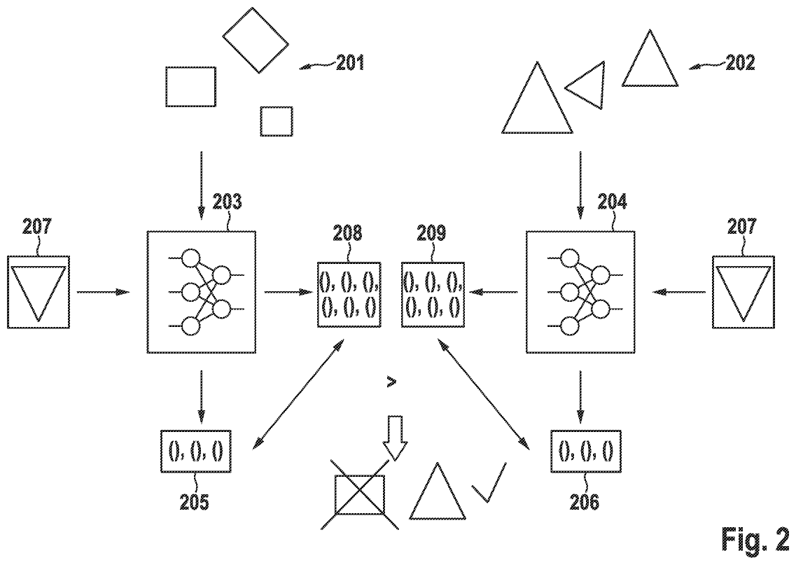

FIG. 2 illustrates the aforementioned procedure.

For the sake of simplicity, a first object class 201 contains quadrilaterals and a second object class 202 contains triangles (wherein 3D objects are typically used in practice). For each of these object classes, a respective machine learning model 203, 204 (which can be instances of the same model) is trained.

Reference descriptors 205, 206 of reference key points (in the descriptor space) are stored for both model instances or object classes. During the inference, an RGB image of a triangle in a new pose is presented as an object of unknown class 207, for example. This is mapped to a descriptor image 208, 209 using each machine learning model 203, 204. The stored reference descriptors 205, 206 can be used to identify the associated object class and thus it can be recognized that the second machine learning model 204 has to be used for the inference to return the correct descriptor image for the object 207.

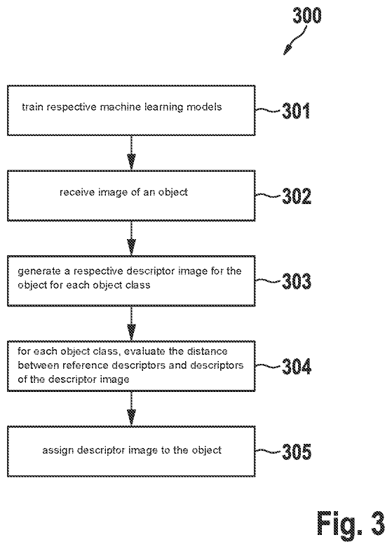

In summary, a method is provided according to various embodiments as shown in FIG. 3.

FIG. 3 shows a flowchart 300 depicting a method for ascertaining a descriptor image for an image of an object (e.g. for a controller of a robot device), according to one embodiment.

In 301, for each of a plurality of object classes, a respective machine learning model (also referred to in the above examples as a respective “model instance”) is trained to map images of objects of the object class to descriptor images, and reference descriptors output by the machine learning model for one or more objects of the object class (i.e. descriptors comprising descriptor images output by the machine learning model for (e.g. training) images of objects of the respective class) are stored. The reference descriptors are, for instance, descriptors that the machine learning model outputs, for example for predetermined, i.e. fixed, reference key points (i.e. feature points such as corners, a point of a handle, etc.) of objects of the object class (i.e. reference key points that all objects of the object class have, e.g. a handle).

In 302, an image of an object (for which it is unknown to which object class it belongs) is received (e.g. from a camera such as the camera 114).

In 303, for each object class, a respective descriptor image for the object (for which the image was received) is generated by mapping the received image to a descriptor image using the machine learning model trained for the object class.

In 304, for each object class, the distance (i.e. a distance measure) between the reference descriptors stored for the object class and the descriptors of the descriptor image generated for the object class is evaluated.

In 305, the descriptor image is assigned to the object as the descriptor image of the object that was generated for the object class for which the distance between the reference descriptors stored for the object class and the descriptors of the descriptor image generated for the object class was rated to be the smallest (i.e. the descriptor image that best matches “its” object class (i.e. matches the reference descriptors of the machine learning model by which it was generated) is taken as the descriptor image of the object).

An object class can contain one or more objects, which can be very different depending on the application. For instance, one object class can be bolts and another object class can be nuts, one object class can be a first type of vehicle body parts, and another object class can be a second type of vehicle body parts, etc.

The method of FIG. 3 can be carried out by one or more computers comprising one or more data processing units. The term “data processing unit” can be understood to mean any type of entity that enables the processing of data or signals. The data or signals can, for example, be processed according to at least one (i.e. one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be carried out (e.g. implemented) by a data processing unit by means of one or more specific functions executed by the data processing unit.

According to various embodiments, therefore, the method is in particular computer-implemented.

Using the descriptor image (e.g. using the descriptor image to ascertain an object pose or to ascertain locations to be processed) ultimately makes it possible to generate a control signal for a robot device. Relevant locations of any type of objects for which the machine learning model has been trained can be ascertained. The term “robot device” can be understood to refer to any physical system, e.g. a computer-controlled machine, vehicle, household appliance, power tool, manufacturing machine, personal assistant or access control system. A control rule for the physical system is learned, and the physical system is then controlled accordingly.

Images are taken using an RGB-D (color image plus depth) camera, for example, descriptor images are ascertained for these images and relevant locations in the workspace of the robot device are ascertained and the robot device is controlled depending on the ascertained locations. An object (i.e. its position and/or pose) can be tracked in input sensor data for example.

The camera images are RGB images or RGB-D (color image plus depth) images, for example, but can also be other types of camera images such as (only) depth images or thermal, radar, LiDAR, ultrasound or motion images or sequences of such images (i.e. a time series). The descriptor images ascertained for this purpose can be used to ascertain object poses, for example to control a robot, for example for assembling a larger object from subobjects, moving objects, etc. The approach of FIG. 3 can be used for any pose ascertainment method. Relevant locations ascertained from the descriptor images can be used, for example, to ascertain the position of locations of an object at which the object can be grabbed (or also sucked in) by a robot and those at which it should not be grabbed. They thus provide valuable information for a manipulation task, for example.

In other words, based on a sensor signal (camera images as described above), information about elements (e.g. objects) encoded by the sensor signal can be obtained (i.e. an indirect measurement can be carried out based on the sensor signal being used as the direct measurement).

The ascertained descriptor image can also be used to classify sensor data (camera images as described above), e.g. to detect the presence of objects in the sensor data or for semantic segmentation of the sensor data, e.g. with respect to traffic signs, pedestrians, vehicles, or any objects in the vicinity of a respective robot device.

Continuous values can be determined as well (i.e. a regression analysis can be carried out); e.g. an object can be tracked in the sensor data. In addition, a dense visual correspondence as provided by descriptor images can be used for anomaly detection in image data. For instance, the presence or absence of an object or part of an object in a scene can be detected by tracking key points. Upon detection of an anomaly, for example, a safe mode of the respective robot device can be activated, e.g. by means of a camera image for which a specific key point is detected (using a descriptor assigned to it).

Although specific embodiments have been illustrated and described here, those skilled in the art in the field will recognize that the specific embodiments shown and described may be exchanged for a variety of alternative and/or equivalent implementations without departing from the scope of protection of the present invention. This application is intended to cover any adaptations or variations of the specific embodiments discussed here.

What is claimed is:

1. A method for ascertaining a descriptor image for an image of an object, comprising the following steps:
training, for each object class of a plurality of object classes, a respective machine learning model to map images of objects of the object class to descriptor images and storing reference descriptors output by the machine learning model for one or more objects of the object class;
receiving an image of an object;
generating, for each object class, a respective descriptor image for the object by mapping the received image to a descriptor image using the machine learning model trained for the object class;
evaluating, for each object class, a distance between the reference descriptors stored for the object class and the descriptors of the descriptor image generated for the object class; and
assigning the descriptor image to the object as the descriptor image of the object generated for that object class for which the distance between the reference descriptors stored for the object class and the descriptors of the descriptor image generated for the object class was rated to be smallest.

2. The method according to claim 1, wherein the distance between the reference descriptors and the descriptor image is evaluated by assigning each of the reference descriptors to a descriptor of the descriptor image and averaging the distances between the reference descriptors and their assigned descriptors.

3. The method according to claim 1, wherein a sub-model of at least some of the machine learning models match.

4. The method according to claim 3, further comprising training the sub-model using training data containing objects from all of the object classes.

5. The method according to claim 1, wherein, for each object class, the respective machine learning model is trained using a training data set that contains images of objects of the object class, wherein the objects of the object class are overrepresented in the training data set.

6. The method according to claim 1, wherein at least some of the machine learning models are neural networks.

7. A method for controlling a robot to pick up or process an object, comprising the following steps:
ascertaining a descriptor image of the object according to a method by:
training, for each object class of a plurality of object classes, a respective machine learning model to map images of objects of the object class to descriptor images and storing reference descriptors output by the machine learning model for one or more objects of the object class,
receiving an image of the object,
generating, for each object class, a respective descriptor image for the object by mapping the received image to a descriptor image using the machine learning model trained for the object class,
evaluating, for each object class, a distance between the reference descriptors stored for the object class and the descriptors of the descriptor image generated for the object class, and
assigning the descriptor image to the object as the descriptor image of the object generated for that object class for which the distance between the reference descriptors stored for the object class and the descriptors of the descriptor image generated for the object class was rated to be smallest;
ascertaining a position of a location or a pose for picking up or processing the object in a current control scenario from the ascertained descriptor image; and
controlling the robot to pick up or process the object according to the ascertained position or location or according to the ascertained pose.

8. A control unit configured to ascertain a descriptor image for an image of an object, the control unit configured to:
train, for each object class of a plurality of object classes, a respective machine learning model to map images of objects of the object class to descriptor images and storing reference descriptors output by the machine learning model for one or more objects of the object class;
receive an image of an object;
generate, for each object class, a respective descriptor image for the object by mapping the received image to a descriptor image using the machine learning model trained for the object class;
evaluate, for each object class, a distance between the reference descriptors stored for the object class and the descriptors of the descriptor image generated for the object class; and
assign the descriptor image to the object as the descriptor image of the object generated for that object class for which the distance between the reference descriptors stored for the object class and the descriptors of the descriptor image generated for the object class was rated to be smallest.

9. A non-transitory computer-readable medium on which is stored instructions ascertaining a descriptor image for an image of an object, the instructions, when executed by processor, causing the processor to perform the following steps:
training, for each object class of a plurality of object classes, a respective machine learning model to map images of objects of the object class to descriptor images and storing reference descriptors output by the machine learning model for one or more objects of the object class;
receiving an image of an object;
generating, for each object class, a respective descriptor image for the object by mapping the received image to a descriptor image using the machine learning model trained for the object class;
evaluating, for each object class, a distance between the reference descriptors stored for the object class and the descriptors of the descriptor image generated for the object class; and
assigning the descriptor image to the object as the descriptor image of the object generated for that object class for which the distance between the reference descriptors stored for the object class and the descriptors of the descriptor image generated for the object class was rated to be smallest.
